(19) United States
(12) Patent Application Publication
(10) Pub. No.: US 2020/0032172 A1
(43) Pub. Date: Jan. 30, 2020

(54) ALKALINE PEROXIDE SYSTEM

(71) Applicant: Church & Dwight Co., Inc., Princeton, NJ (US)

(72) Inventor: Steven T. Adamy, Lawrenceville, NJ (US)

(73) Assignee: Church & Dwight Co., Inc., Princeton, NJ (US)

(21) Appl. No.: 16/521,395

(22) Filed: Jul. 24, 2019

Related U.S. Application Data
(60) Provisional application No. 62/702,624, filed on Jul. 24, 2018.

(51) Int. Cl. C11D 3/395; C11D 1/14; C11D 3/00; C11D 17/00; B08B 3/08

(52) U.S. Cl. CPC C11D 3/3953; C11D 1/146; B08B 3/08; C11D 3/0047; C11D 17/003; C11D 3/3951

(57) ABSTRACT

An alkaline liquid cleaning composition is provided, the cleaning composition including a liquid medium having hydrogen peroxide, water, and nanoparticles dispersed in the liquid medium. The nanoparticles are insoluble in the liquid medium and exhibit an overall negative charge at the particle-liquid interface. The nanoparticles can be nanosilicates.

### CROSS-REFERENCE TO RELATED APPLICATIONS

The present application claims priority to U.S. Provisional Application No. 62/702,624, filed Jul. 24, 2018, the disclosure of which is incorporated herein by reference.

### FIELD OF THE INVENTION

The present invention relates to compositions for cleaning various surfaces, and more particularly to cleaning composition comprising hydrogen peroxide and silica.

### BACKGROUND

This invention relates to a composition that can be used as a cleaner and includes hydrogen peroxide in a solution with colloidal silica, and in particular, silica with an ammonium counterion or deionized silica. Compositions described herein demonstrate improved hydrogen peroxide stability as compared to systems that do not include the silica.

Hydrogen peroxide (H₂O₂) is a well-known oxidizing agent, with a range of applications for bleaching and disinfection. In practice, H₂O₂ is often employed in liquid products formulated at an acidic pH (typically 5 or less) due to the inherent reduced stability of the material at more alkaline pH values. H₂O₂ has an acidic proton with a pKa of 11.7, i.e., H₂O₂ undergoes a dissociation according to formula [1] below. See, e.g., M. Lewin, Chemical Processing of Fiber Fibers and Fabrics, Fundamentals and Preparation, Part B, M. Lewin and S. B. Sello (Ed.), Marcel Dekker, New York, 1984, pp. 176-178 (hereinafter “Lewin”), which is herein incorporated by reference in its entirety.

H₂O₂↔H⁺HOO⁻ [1]

It is also known that the presence of the HOO⁻ anion leads to instability, through the mechanism [2] below.

H₂O₂+HOO⁻→H₂O+OH⁻+O₂ [2]

If metal ions are present, such as Fe³⁺, decomposition is accelerated through the following mechanism. See, e.g., W. C. Schumb, C. N. Satterfield, and R. L. Wentworth, Hydrogen Peroxide, Reinhold Publishing Corp., New York, 1955, p. 492, which is herein incorporated by reference in its entirety.

Fe³⁺+HOO⁻→Fe²⁺+.OOH [3a]

Fe²⁺+H₂O₂→Fe³⁺+.OH+OH⁻ [3b]

H₂O₂+.OH→OOH+H₂O [3c]

Fe²⁺+.OOH→Fe³⁺+HOO⁻ [3d]

Fe³⁺+.OOH Fe²⁺+H⁺O₂ [3e]

It is therefore desirable to maintain a more acidic pH in order to stabilize H₂O₂. However, for bleaching processes, it can be helpful to have a peroxide system at an alkaline pH in order to generate the active HOO— species, and to minimize the decrease in pH that may be associated with adding a peroxide bleach additive to a wash load.

Accordingly, there is still a desire and a need to provide a stable bleaching system based on H₂O₂ that exhibits good peroxide stability at an alkaline pH.

### SUMMARY OF THE INVENTION

In one aspect of the present invention, a liquid cleaning composition comprising a liquid medium comprising hydrogen peroxide, water and nanoparticles dispersed in the liquid medium, wherein said nanoparticles are insoluble in the liquid medium and exhibit an overall negative charge at the particle-liquid interface and said composition is alkaline. In various embodiments, the nanoparticles have a particle size of at least about 5 nm, at least about 10 nm, or at least about 20 nm. In some embodiments, the nanoparticles are nanosilicates. In certain embodiments, the nanosilicates include an ammonium counter ion. In certain embodiments, the nanosilicates are deionized such that counterions like sodium have been removed (while maintaining a negative surface charge). In various embodiments, the pH of the cleaning composition is between 7 and 10.

A method of cleaning a substrate is also provided herein. The method can include applying the compositions of the present disclosure to a substrate. The substrate can include, for example, laundry, fabrics (e.g., clothing, furniture, carpets), hard surfaces such as countertops, floors, exterior surfaces (e.g., decks, sidewalks, vehicles), etc. The substrate can have soils, stains, mold, mildew, etc., which can be at least partially removed by cleaning compositions described herein. The stains to be removed can include hydrophobic stains (e.g., food stains containing oil such as pasta sauce) and hydrophilic stains (e.g., red wine, tea, etc.).

A method of preparing an alkaline peroxide cleaning composition is also provided herein.

Other aspects and advantages of the present invention will become apparent from the following.

### BRIEF DESCRIPTION OF THE DRAWINGS

FIG. 1a is a plot of the fraction of H₂O₂ remaining in the solution after 2 weeks;

FIG. 1b is a plot of the ratio of final pH to the initial pH of sample cleaning solutions after 2 weeks time;

FIG. 2a is a plot of the fraction of peroxide remaining after 2 weeks for systems with and without SDS;

FIG. 2b is a plot of the fraction of peroxide remaining after 4 weeks for systems with and without SDS;

FIG. 3 is a time-dependent plot of data at 0, 1, and 5% silica in systems with 5% SDS;

FIG. 4a is a bar graph showing the percent stain removal results for red wine for exemplary compositions of the present disclosure;

FIG. 4b is a bar graph showing the percent stain removal results for tea for exemplary compositions of the present disclosure; and

FIG. 5a is a plot of the fraction of peroxide remaining after 2 weeks for various sample cleaning compositions according to the present disclosure;

FIG. 5b is a plot of the ratio of final pH to the initial pH of sample cleaning solutions after 2 weeks time;

FIG. 6a is a plot of the fraction of peroxide remaining after 2 weeks for various sample cleaning compositions according to the present disclosure; and

FIG. 6b is a plot of the ratio of final pH to the initial pH of sample cleaning solutions after 2 weeks time.

### DETAILED DESCRIPTION OF THE INVENTION

The present disclosure now will be described more fully hereinafter with reference to the accompanying drawings. The disclosure may be embodied in many different forms and should not be construed as limited to the embodiments set forth herein; rather, these embodiments are provided so that this disclosure will satisfy applicable legal requirements. Like numbers refer to like elements throughout. As used in this specification and the claims, the singular forms “a,” “an,” and “the” include plural references unless the context clearly dictates otherwise.

In one aspect of the present invention, a composition that can be useful for cleaning is provided, the composition comprising hydrogen peroxide, water and nanoparticles dispersed in a liquid medium, wherein said nanoparticles are insoluble in the liquid medium and exhibit an overall negative charge at the particle-liquid interface. Compositions described herein can be alkaline.

In various embodiments, the compositions described herein can include hydrogen peroxide. In some embodiments, the hydrogen peroxide can be provided in a solution. For example, the composition can include about 1-20%, or about 5-15%, or about 3-12% H₂O₂ (aq)(w/v). The total weight of H₂O₂ in the cleaning composition can be at least about 1 wt. %, at least about 3 wt. %, at least about 5 wt. %, or at least about 10 wt. %, based on the total weight of the aqueous composition.

In various embodiments, the cleaning composition can comprise a liquid medium. In some embodiments, the liquid medium is water. The total weight of the liquid medium in the cleaning composition can be at least about 50 wt %, at least about 65 wt. %, at least about 75 wt. %, or at least about 85 wt. %.

Compositions described herein can further include colloidal silica. Colloidal silicas are suspensions of fine amorphous, nonporous, and typically spherical silica particles in a liquid phase. Colloidal silicas are most often prepared in a multi-step process where an alkali-silicate solution is partially neutralized, leading to the formation of silica nuclei. The subunits of colloidal silica particles are typically in the range of 1 to 5 nm. Whether or not these subunits are joined together depends on the conditions of polymerization. Initial acidification of a waterglass (sodium silicate) solution yields Si(OH)₄. If the pH is reduced below 7 or if salt is added, then the units tend to fuse together in chains (i.e., polymers of SiO), often referred to as silica gels. If the pH is kept slightly above 7 (i.e., alkaline), then the subunits stay separated (i.e., dispersion of fine particles), and are often referred to as precipitated silica or silica sols. The surface area of colloidal silica is very high due to the small size of the particles.

In various embodiments, the colloidal silica is nano-sized. The nano-sized silica can have an average particle size in the range of 1-50 nm, or about 5-30 nm, or about 10-25 nm, for example. In certain embodiments, the nano-silica particles can be deionized. In some embodiments, the nano-silica particles can include a counter ion. Hydrogen ions from the surface of colloidal silica tend to dissociate in aqueous solution, yielding a high negative charge. Substitution of some of the Si atoms by counter ions can increase the negative colloidal charge. In certain embodiments, the counter ion is Na⁺ or NH₄⁺.

It was surprisingly discovered that the inclusion of nano-sized colloidal silica (particle size˜22 nm diameter) provided improved stability of H₂O₂ in aqueous systems having a pH of about 9.5. The stability improvement was especially pronounced in nanosilicates having an ammonium (NH₄⁺) counter ion. It is noted that H₂O₂ typically exhibits poor stability at alkaline pH levels, however, alkaline pH levels are desired for cleaning efficacy. The reactive species HOO⁻ is also more readily formed at alkaline pH (with the pKa of H₂O₂ being 11.7).

The total concentration of colloidal silica in the cleaning compositions described herein can be at least about 1% (w/v), at least about 5% (w/v), at least about 10% (w/v), or at least about 20% (w/v).

In certain embodiments, the colloidal silica suspension can be stabilized by pH adjustment and then concentrated, usually by evaporation. The maximum concentration obtainable can depend on the particle size. For example, 50 nm particles can be concentrated to greater than 50 wt % solids while 10 nm particles can be concentrated to approximately 30 wt % solids before the suspension becomes too unstable.

The cleaning compositions described herein can further include a buffer. In various embodiments, the buffer can be borax (sodium tetraborate decahydrate—Na₂[B₄O₅(OH)₄].8H₂O). Other buffers appropriate for this invention include but are not limited to: sodium tetraborate pentahydrate (Na₂B₄O₇.5H₂O), disodium octaborate tetrahydrate (Na₂B₈O₁₃.4H₂O), sodium bicarbonate (NaHCO₃), sodium carbonate (Na₂CO₃), sodium dihydrogen phosphate (NaH₂PO₄), sodium biphosphate (Na₂HPO₄), trisodium phosphate (Na₃PO₄), triethanolamine [(HOCH₂CH₂)₃N], diethanolamine [HN(CH₂CH₂OH)₂], monethanolamine (NH₂CH₂CH₂OH), glycine (NH₂CH₂COOH), and combinations thereof. The buffer can be configured to buffer the cleaning compositions described herein in the range of about pH 7 to about pH 10, for example.

In various embodiments, the initial pH of the cleaning composition after mixing is in the range of about 6 to about 10, or about 7 to about 10, or about 8 to about 10. In certain embodiments, the initial pH of the cleaning composition after mixing is about 8.5 to about 10. In some embodiments, the pH of the cleaning composition is at least about 7, at least about 8, or at least about 9.

Some embodiments of the aqueous cleaning compositions of the present disclosure can further comprise a surfactant. For example, the cleaning compositions can comprise a nonionic surfactant, an anionic surfactant, or combinations thereof. In some embodiments, it can be advantageous for a nonionic surfactant to be present in an amount of at least 50% by weight based on the total weight of surfactant employed. As is understood by those skilled in the art, nonionic surfactants lower the critical micelle concentration, and achieve superior oil removal. In certain embodiments, the composition can comprise at least one surfactant selected from the group consisting of 12-15 carbon alcohol ethoxylate with 7 moles ethylene oxide per mole of alcohol (e.g., Neodol 25-7 and other similar products available from Shell Global), 12-carbon alkylbenzene sulfonic acid neutralized with monoethanolamine, and sodium laureth sulfate having 2-5 moles ethylene oxide (e.g., Steol® products available from Stepan Company). In some embodiments, the cleaning solution can include sodium dodecyl sulfate (SDS).

The total weight of the at least one surfactant in the cleaning compositions described herein can be at least about 1 wt. %, at least about 5 wt. %, at least about 10 wt. %, at least about 20 wt. %, or at least about 50 wt. %, based on the total weight of the aqueous composition.

A method of preparing an aqueous cleaning composition is also provided herein. In various embodiments, the method of preparing the cleaning composition can comprise mixing a liquid medium, H₂O₂, a buffer, at least one surfactant, and nano-sized silica to form a substantially homogeneous solution. It is recommended that compositions be formulated such that the buffering substance is added to water first, followed by the surfactant, followed by the colloidal silica, followed by the hydrogen peroxide. In some embodiments, the method of preparing an aqueous cleaning composition can further include preparing a cleaning article by placing a measured amount of the aqueous cleaning composition into a package suitable for a consumer to purchase.

### EXPERIMENTAL

### Example 1

Different nano-sized colloidal silicas were tested. A series of compositions were prepared containing H₂O₂, a borax buffer solution, water, sodium dodecyl sulfate (SDS), and one of eight different colloidal silicas. The silicas are sold under the trade name Ludox® (Grace) and have different characteristics. Properties of the silicas are listed in Table 1 below.

TABLE 1
Silica Properties

| | | Approx. |
|---|---|---|
| | | particle size |
| Silica | Counter ion | (nm) |
| Ludox TM40 (40% AI) | Na⁺ | 22 |
| Ludox AM (30% AI) | Na⁺ | 12 |
| Ludox Cl (30% AI) | Cationic (not specified) | 12 |
| Ludox AS-40 (40% AI) | NH₄+ | 22 |
| Ludox CL-X (45% AI) | Na⁺ | 22 |
| Ludox TMA (34% AI) | deionized | 22 |
| Ludox SM (30% AI) | Na⁺ | 7 |
| Ludox HS30 (30% AI) | Na⁺ | 12 |

Formulas were prepared according to the following compositions listed in Table 2 below. All formulas (except for the controls with no silica) were prepared with 10% silica (w/b) and 3% H₂O₂ (w/v) on an actives basis. The compositions were formulated to maintain a constant volume while varying the levels of silica and SDS. Compositions below are shown in terms of parts by mass and do not necessarily sum to 100.

TABLE 2
Sample Compositions

| | | | Ludox | Ludox | Ludox | Ludox | Ludox | Ludox | Ludox | Ludox | | H₂O₂ |
|---|---|---|---|---|---|---|---|---|---|---|---|---|
| | | | TM40 | AM | Cl | AS-40 | CL-X | TMA | SM | HS30 | | (50% |
| | 0.013M | | (40% | (30% | (30% | (40% | (45% | (34% | (30% | (30% | | w/w in |
| Sample | borax | water | AI) | AI) | AI) | AI) | AI) | AI) | AI) | AI) | SDS | water) |
| 1 | 79 | 15 | | | | | | | | | | 6 |
| 2 | 79 | | 25 | | | | | | | | | 6 |
| 3 | 70.67 | | | 33.33 | | | | | | | | 6 |
| 4 | 70.67 | | | | 33.33 | | | | | | | 6 |
| 5 | 79 | | | | | 25 | | | | | | 6 |
| 6 | 79 | 2.78 | | | | | 22.22 | | | | | 6 |
| 7 | 74.59 | | | | | | | 29.41 | | | | 6 |
| 8 | 70.67 | | | | | | | | 33.33 | | | 6 |
| 9 | 70.67 | | | | | | | | | 33.33 | | 6 |
| 10 | 79 | 15 | | | | | | | | | 5 | 6 |
| 11 | 79 | | 25 | | | | | | | | 5 | 6 |
| 12 | 70.67 | | | 33.33 | | | | | | | 5 | 6 |
| 13 | 70.67 | | | | 33.33 | | | | | | 5 | 6 |
| 14 | 79 | | | | | 25 | | | | | 5 | 6 |
| 15 | 79 | 2.78 | | | | | 22.22 | | | | 5 | 6 |
| 16 | 74.59 | | | | | | | 29.41 | | | 5 | 6 |
| 17 | 70.67 | | | | | | | | 33.33 | | 5 | 6 |
| 18 | 70.67 | | | | | | | | | 33.33 | 5 | 6 |

The samples were prepared by placing the borax solution and the water in a beaker. The mixture was then stirred with a magnetic stirrer. SDS was then added and dissolved. The silica dispersion was then added, followed by the 50% H₂O₂ solution. Values of pH following formulation were typically around 7.5. The pH was adjusted to about 9.5 with 50% NaOH (a few drops added to samples of about 200 g). Final pH values are shown in Table 3 below.

Peroxide levels were also assessed via titration with 0.1 N Ce(SO₄)₂ under acidic conditions. In the Ce⁴⁺ titration, the following reactions are considered:

Ce⁴⁺+H₂O₂→HO₂⁻+H⁺+Ce³⁺

Ce⁴⁺+HO₂→O₂++Ce³⁺

Net:2Ce⁴⁺+H₂O₂→O₂+2H⁺+Ce³⁺

Titrations were performed by adding 0.5 g to 1.0 g of product to a plastic cup, sized to fit in a Metrohm autotitrator. The aliquot was then acidified with 5.0 mL of 10% H₂SO₄(aq) (w/v). The sample was then loaded into the autotitrator, where approximately 10 mL was added to the sample, and the potential of a probe electrode was monitored while dosing the sample with the 0.1 N Ce(SO₄)₂ solution. The endpoint was indicated by a potential change from about −200 mV to −900 mV. In some cases where the peroxide level was very low, the titration was performed manually. Initial pH values and peroxide levels are shown in Table 3 below.

TABLE 3
Initial pH values and peroxide levels after titrations

| Sample | pH | % H202 |
|---|---|---|
| 1 | 9.56 | 3.087 |
| 2 | 9.56 | 2.954 |
| 3 | 9.44 | 2.862 |
| 4 | 9.44 | 2.805 |
| 5 | 9.51 | 2.830 |
| 6 | 9.60 | 2.815 |
| 7 | 9.42 | 2.793 |
| 8 | 9.43 | 2.801 |
| 9 | 9.42 | 2.832 |
| 10 | 9.45 | 2.953 |
| 11 | 9.57 | 2.708 |
| 12 | 9.55 | 2.676 |
| 13 | 9.52 | 2.648 |
| 14 | 9.64 | 2.663 |
| 15 | 9.63 | 2.744 |
| 16 | 9.50 | 2.686 |
| 17 | 9.50 | 2.729 |
| 18 | 9.54 | 2.714 |

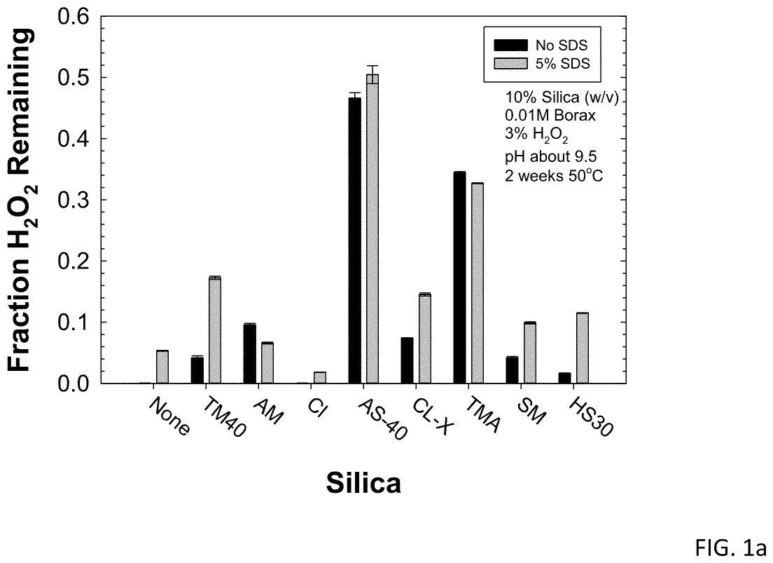

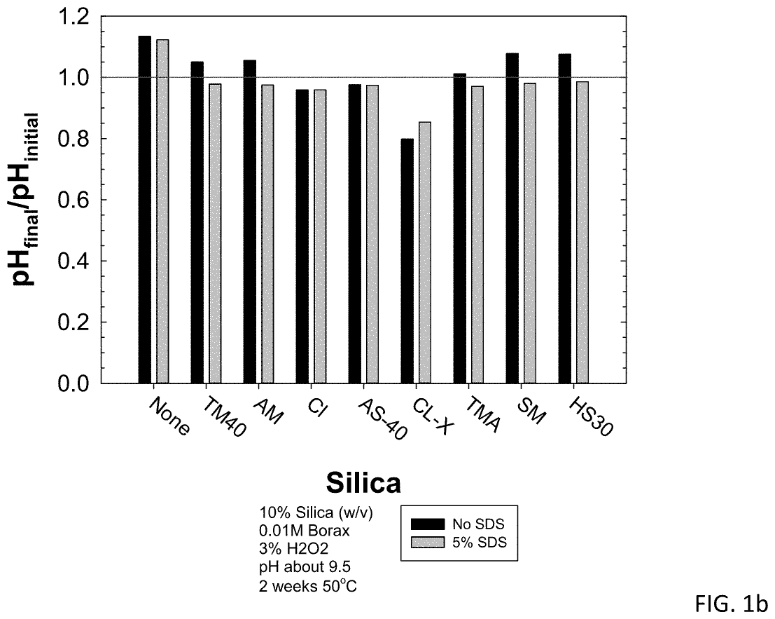

The samples were placed in glass jars and incubated at 50° C. for 2 weeks. Following the incubation period, pH and H₂O₂ levels were assessed. FIGS. 1a and 1b are plots indicating the fractions of peroxide remaining and the final pH levels normalized to the initial levels. Hence, a pH ratio of greater than 1 represents an increase in pH while a ratio of less than 1 represents a decrease in pH.

The data indicate that the most stable system was the AS40 system, containing the silica with the NH₄⁺ counter ion. The next most stable system was the TMA system, containing the deionized form. Systems with the Na⁺ counter ion were slightly more stable than the systems with no silica or the Cl cationic system. Without being limited by theory, the differences in stability may have in part been related to drifts in pH, although systems like the Cl system, which exhibited a decrease in pH were still highly unstable.

### Example 2

Based on the results from Example 1, additional samples of cleaning compositions including the AS40 silica (i.e., silica with NH₄⁺ counter ion) were prepared. The level of silica (on an actives basis) was adjusted from 0 to 15% (w/v) and the level of H₂O₂ was held constant at 3% (w/v). The compositions are shown in Table 4 below. As in Example 1, samples were formulated to maintain a constant volume. Levels of components are shown in terms of parts by weight.

TABLE 4
Cleaning compositions samples including
silica with NH₄⁺ counter ion

| | 0.02M | | | H₂O₂ (Peroxal | |
|---|---|---|---|---|---|
| Sample | Borax | water | Ludox AS40 | CLG 50) | SDS |
| 1 | 50 | 44 | 0 | 6 | |
| 2 | 50 | 42.5 | 2.5 | 6 | |
| 3 | 50 | 36.5 | 12.5 | 6 | |
| 4 | 50 | 29 | 25 | 6 | |
| 5 | 50 | 21.5 | 37.5 | 6 | |
| 6 | 50 | 44 | 0 | 6 | 5 |
| 7 | 50 | 42.5 | 2.5 | 6 | 5 |
| 8 | 50 | 36.5 | 12.5 | 6 | 5 |
| 9 | 50 | 29 | 25 | 6 | 5 |
| 10 | 50 | 21.5 | 37.5 | 6 | 5 |

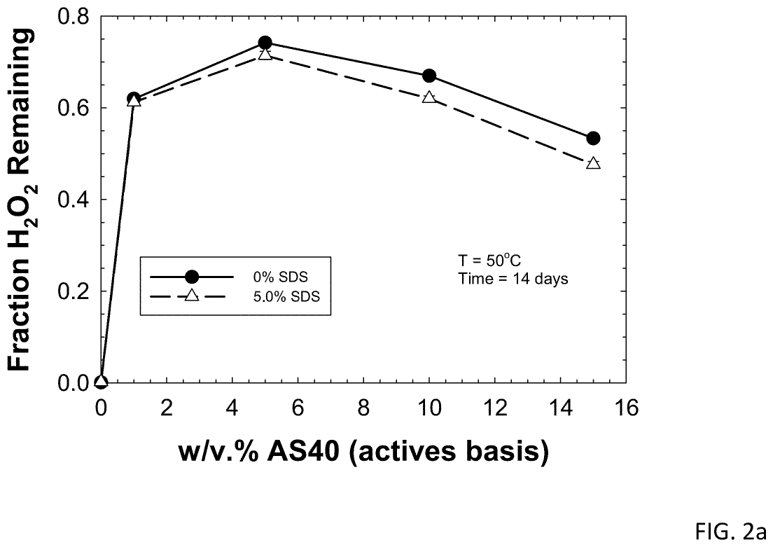

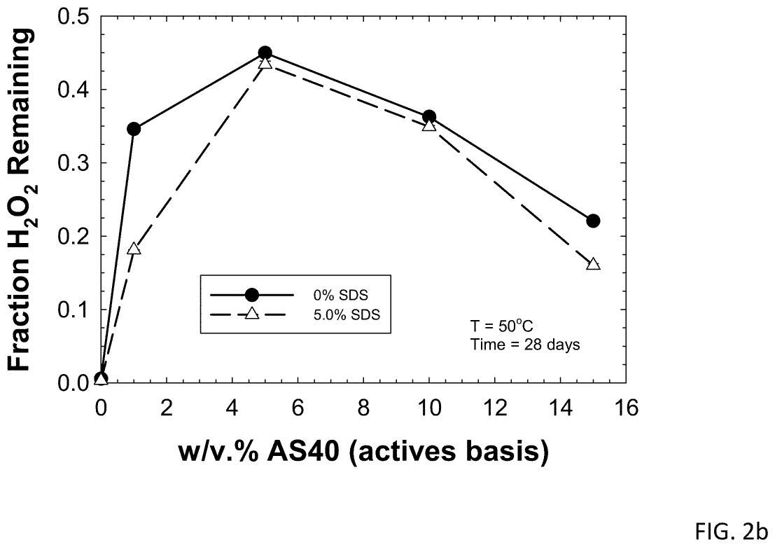

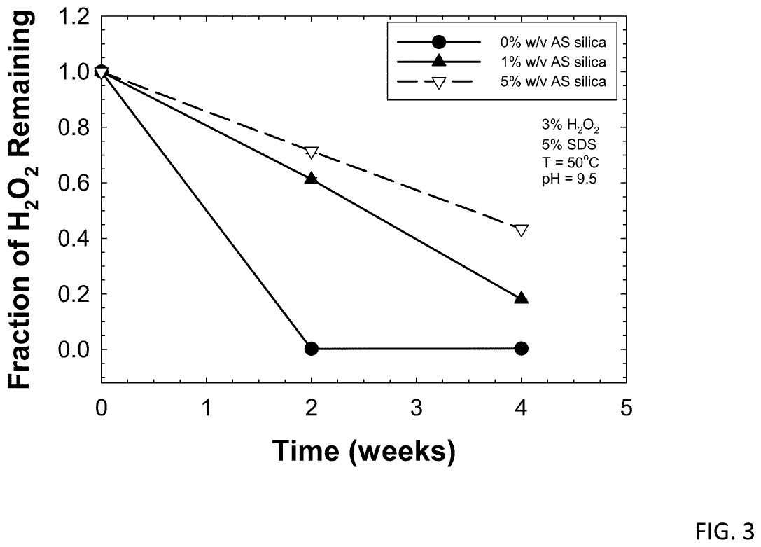

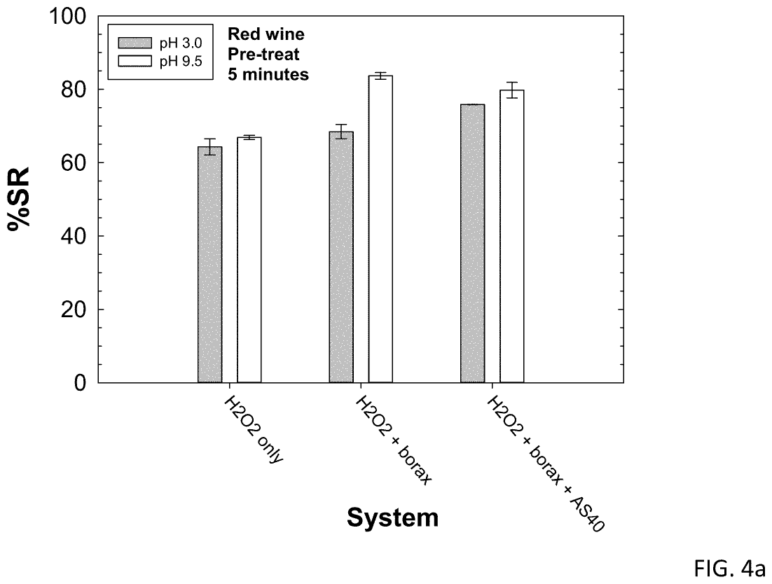

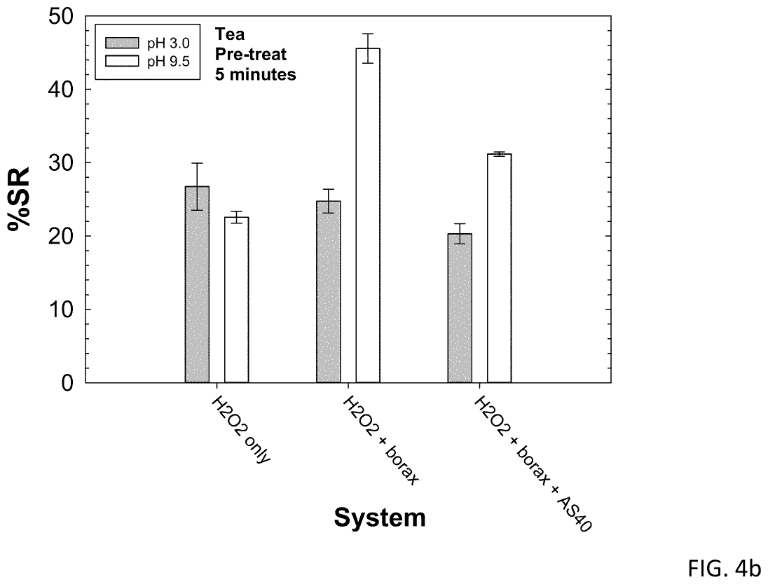

Formula pH values were adjusted as noted in Example 1 above. Peroxide levels at time zero and after samples had been incubated for both 2 weeks and 4 weeks at 50° C. were also assessed. FIGS. 2a and 2b are plots of the fraction of peroxide remaining after 2 weeks (FIG. 2a) and 4 weeks (FIG. 2b) for systems with and without SDS. The stability studies indicated that about 5% silica was optimal for stability. FIG. 3 is a time-dependent plot of data at 0, 1, and 5% silica in systems with 5% SDS added.

### Example 3

In order to demonstrate the benefit of employing an alkaline peroxide system for stain removal, compared to a peroxide system at an acidic pH, a series of compositions were prepared which contained the components described above, but were adjusted to pH levels of either 3.0 or 9.5. The systems are described in Table 5 below. Levels of components are shown in terms of parts by weight.

TABLE 5
Sample Compositions

| | | | | H₂O₂ | | |
|---|---|---|---|---|---|---|
| | 0.02M | | Ludox | (Peroxal | | |
| Sample | Borax | water | AS40 | CLG 50) | SDS | Comments |
| 1 | 0 | 94 | | 6 | 5 | adjust to pH 3 |
| 2 | 0 | 94 | | 6 | 5 | adjust to pH 9.5 |
| 3 | 50 | 44 | | 6 | 5 | adjust to pH 3 |
| 4 | 50 | 44 | | 6 | 5 | adjust to pH 9.5 |
| 5 | 50 | 36.5 | 12.5 | 6 | 5 | adjust to pH 3 |
| 6 | 50 | 36.5 | 12.5 | 6 | 5 | adjust to pH 9.5 |

Adjustment of pH was performed with either concentrated H₂SO₄ (98%) or 50% NaOH. The samples were loaded into 4 oz. plastic pump sprayer bottles. Swatches (2.5″×2.5″) of red wine on cotton 400 or tea on cotton 400 were sprayed 10 times to fully saturate the swatch and allowed to stand for 5 minutes. The swatches were then rinsed with tap water, squeezed to remove excess water, and allowed to air dry. Two replicates were run for each stain and treatment.

Stain removal was evaluated by comparing color assessments on swatches before treatment and after treatment. Color assessments in the CIE L*a*b* color space were performed on non-treated and treated swatches via a BYK Gardner Color-view spectrophotometer. Values of ΔE, a root mean square color difference between the swatch and a non-soiled standard swatch, were then calculated for non-treated and treated swatches according to:

ΔEᵤ=[(Lᵤ−Lₒ)²+(aᵤ−aₒ)²(bᵤ−bₒ)²]^{1/2} Before treatment:

ΔE_{w}=[(L_{w}−Lₒ)²+(a_{w}−aₒ)²(b_{w}−bₒ)²]^{1/2} After treatment:

where u, w, and o correspond to values for non-treated swatch, treated swatches, and non-stained swatches, respectively. The percentage of stain removal (% SR) was then calculated according to:

% SR=[(ΔEᵤ−ΔE_{w})/ΔEᵤ]×100

FIGS. 4a and 4b show the percent stain removal results for red wine (FIG. 4a) and tea (FIG. 4b) comparing pH 3 (light grey) and pH 9.5 (dark grey) systems. In the case of red wine, increasing the pH increased % SR in all three systems, although the effect was most pronounced in the borax only system. Both borax only and borax+silica systems showed superior performance to the peroxide only system. From the previous examples, however, it was shown that systems with borax alone were highly unstable. With the added stability imparted by the colloidal silica, the borax+silica system exhibited a superior combination of stability and stain removal efficacy.

In the tea system, increasing the pH was helpful in stain removal, except in the case of the peroxide only system. Again, the borax only system was the most effective stain remover at high pH, but the silica system, with superior stability, offered the advantage of good stability along with stain removal.

### Example 4

The following example explores whether the nano-sized colloidal silica provided improved stability over typical silicates, which are solutions of monomeric and polymeric silicate species. These silicate solutions are sometimes referred to as “waterglass.” A series of compositions were prepared to compare the nanosilicate colloid Ludox AS40 to a silicate solution. As noted above, AS40 exhibited the best stability of all nanosilicates examined. AS40 (40% AI) contains an ammonium counter ion and an average particle size of about 22 nm.

Because a traditional silicate with an NH₄⁺ counter ion was not available, NH₄OH was added to mixtures with a traditional Na-silicate (PQ silicate N). Levels of NH₄OH reflected a 1/1 molar ratio with the level of anionic sites available in the silicate. The compositions are shown below along with comments. Mixtures were formulated, and pH levels were adjusted to about 9.5 with 50% NaOH or concentrated H₂SO₄. All values are in parts based on weight.

TABLE 6
Sample Cleaning Compositions

| | | | % | Ludox | PQ | | Peroxal | | |
|---|---|---|---|---|---|---|---|---|---|
| | 0.02M | | Silicate | AS40 | silicate N | | CLG | | |
| | Borax | | (Actives | (40% | (37.6% | NH₄OH | (50% | | |
| Sample | (aq) | water | basis) | AI) | AI) | 29% | H₂O₂) | pH | Comments |
| 1 | 50.00 | 44.00 | 0 | 0.00 | | | 6.00 | 9.55 | |
| 2 | 50.00 | 42.50 | 1 | 2.50 | | | 6.00 | 9.48 | |
| 12 | 50.00 | 39.50 | 3 | 7.50 | | | 6.00 | 9.50 | |
| 3 | 50.00 | 36.5 | 5 | 12.50 | | | 6.00 | 9.52 | |
| 4 | 50.00 | 21.50 | 15 | 37.50 | | | 6.00 | 9.59 | |
| 5 | 50.00 | 42.34 | 1 | | 2.66 | | 6.00 | 9.59 | |
| 13 | 50.00 | 39.02 | 3 | | 7.98 | | 6.00 | 9.55 | |
| 6 | 50.00 | 35.70 | 5 | | 13.30 | | 6.00 | 9.54 | Gel formed after |
| | | | | | | | | | 1 day |
| 7 | 50.00 | 19.11 | 15 | | 39.89 | | 6.00 | | Gel formed |
| | | | | | | | | | immediately |
| 8 | 50.00 | 43.10 | 0 | | | 12.64 | 6.00 | 9.54 | |
| 9 | 50.00 | 42.28 | 1 | | 2.66 | 0.90 | 6.00 | 9.50 | |
| 14 | 50.00 | 38.83 | 3 | | 7.98 | 2.69 | 6.00 | 9.58 | Gel formed after |
| | | | | | | | | | 30 minutes |
| 10 | 50.00 | 35.38 | 5 | | 13.30 | 4.48 | 6.00 | | Gel formed |
| | | | | | | | | | immediately |

It was obvious right away from the formulations that a higher level of silicate could be included in samples with the Ludox nanosilicate as opposed to the Silicate N without gel formation. Table 7 below summarizes the observations.

TABLE 7
Gel Formation

| | | Silicate N | Silicate N |
|---|---|---|---|
| % Silicate | Nanosilica | No NH₄OH | w/NH₄OH |
| 0 | Liq | Liq | Liq |
| 1 | Liq | Liq | Liq |
| 3 | Liq | Lig | gel |
| 5 | Liq | gel | gel |
| 15 | Liq | gel | gel* |

To assess stability, the samples were incubated for 2 weeks at 50° C. Peroxide levels were assessed at time zero and after incubation via titration with 0.1 N Ce(SO₄)₂ under acidic conditions (as described in Example 1 above). Note that levels of peroxide were assessed in terms of wt. %. Peroxide levels at time zero and after two weeks are shown in Table 8 below. Also shown are values for the fraction of peroxide remaining after incubation.

TABLE 8
Peroxide Levels after Incubation

| | % | | | | | | Fract | |
|---|---|---|---|---|---|---|---|---|
| | Silicate | | | | Ave wt. % | | H₂O₂ | |
| | (Actives | Silicate | Ave wt. % | | H₂O₂ 2 | err 2 weeks | weeks | err |
| Sample | basis) | Type | H₂O₂ t0 | err t0 | weeks 50° C. | 50° C. | 50° C. | fract |
| 1 | 0 | None | 3.014 | 0.008 | 0.000 | 0.000 | 0.000 | |
| 2 | 1 | Nano | 3.005 | 0.005 | 2.497 | 0.025 | 0.831 | 0.008 |
| 12 | 3 | | 2.954 | 0.002 | 2.244 | 0.005 | 0.760 | 0.002 |
| 3 | 5 | | 2.902 | 0.005 | 2.156 | 0.012 | 0.743 | 0.004 |
| 4 | 15 | | 2.629 | 0.007 | 1.374 | 0.004 | 0.522 | 0.002 |
| 5 | 1 | Regular | 3.027 | 0.014 | 1.338 | 0.001 | 0.442 | 0.000 |
| 13 | 3 | Na-silicate | 2.944 | 0.001 | 0.572 | 0.001 | 0.194 | 0.000 |
| 6 | 5 | | | | | | | |
| 7 | 15 | | | | | | | |
| 8 | 0 | NH4OH | 2.652 | 0.002 | 0.060 | 0.001 | 0.023 | 0.000 |
| | | only | | | | | | |
| 9 | 1 | Regular | 2.967 | 0.004 | 0.684 | 0.004 | 0.231 | 0.001 |
| 14 | 3 | NH₄- | | | | | | |
| 10 | 5 | silicate | | | | | | |

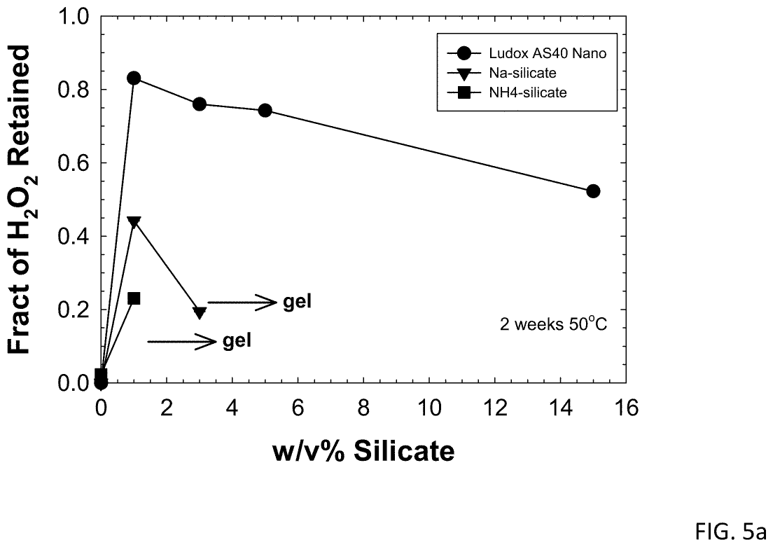

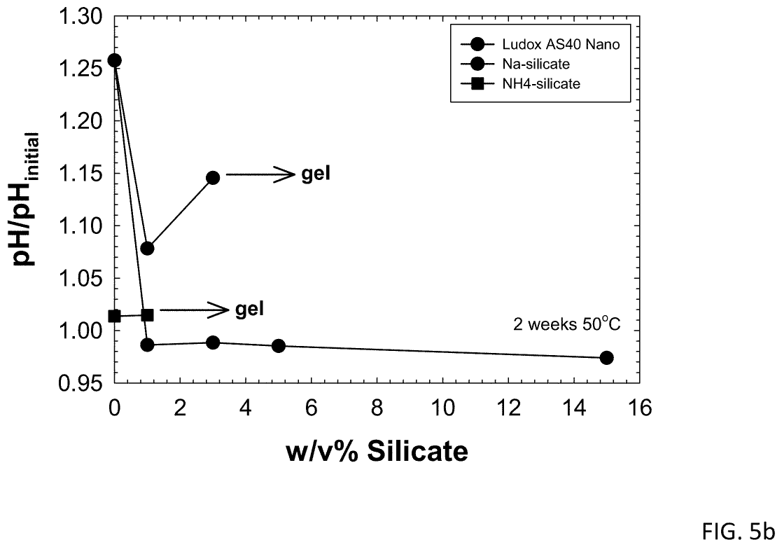

It was apparent that the amounts of peroxide retained were far higher in the nanosilicate systems compared with the regular silicate systems. That data are shown graphically in FIG. 5a.

Values of pH at time 0 and after 2 weeks at 50° C. are shown in Table 9 below. Also shown is a ratio of the final pH over the initial pH. A ratio of 1 indicates no change in pH, while ratios less than 1 reflect a decrease in pH while ratios greater than 1 reflect increase in pH. FIG. 5b further illustrates the data.

TABLE 9
pH of the sample compositions initially and over time

| | % Silicate | | | | |
|---|---|---|---|---|---|
| | (Actives | | | pH 2 weeks | |
| Sample | basis) | Silicate Type | pH t0 | 50° C. | pH/pH init |
| 1 | 0 | None | 9.55 | 12.01 | 1.26 |
| 2 | 1 | Nano | 9.48 | 9.35 | 0.99 |
| 12 | 3 | | 9.50 | 9.39 | 0.99 |
| 3 | 5 | | 9.52 | 9.38 | 0.99 |
| 4 | 15 | | 9.59 | 9.34 | 0.97 |
| 5 | 1 | Regular Na- | 9.59 | 10.34 | 1.08 |
| 13 | 3 | silicate | 9.55 | 10.94 | 1.15 |
| 6 | 5 | | 9.54 | | |
| 7 | 15 | | | | |
| 8 | 0 | NH₄OH only | 9.54 | 9.67 | 0.96 |
| 9 | 1 | Regular NH4 - | 9.50 | 9.64 | 0.92 |
| 14 | 3 | silicate | 9.58 | | |
| 10 | 5 | | | | |

### Example 5

A series of experiments were then run to assess the dependence of peroxide stability in the nanosilicate systems on particle size. Systems were composed using the silicate materials provided in Table 10 below.

TABLE 10
Silicate Materials

| | | Approx. |
|---|---|---|
| | | particle size |
| Silica | Counter ion | (nm) |
| Ludox AS-40 (40% AI) | NH₄⁺ | 22 |
| Ludox AS-30 (30% AI) | NH₄⁺ | 12 |
| Ludox SM-AS | NH₄⁺ | 7 |

The following compositions provided in Table 11 below were prepared to reach target levels of 0-5% silicate (w/v %).

TABLE 11
Sample Compositions

| | 0.02M | | | Ludox | Ludox | Ludox | Peroxal | |
|---|---|---|---|---|---|---|---|---|
| | Borax | | Wt. | AS40 | AS30 | SM AS | CLG (50% | |
| Sample | (aq) | water | % silicate | (40% Al) | (30% Al) | (25% Al) | H₂O₂) | pH |
| 1 | 50.00 | 44.00 | 0 | 0.00 | | | 6.00 | 9.55 |
| 2 | 50.00 | 42.50 | 1 | 2.50 | | | 6.00 | 9.50 |
| 3 | 50.00 | 39.50 | 3 | 7.50 | | | 6.00 | 9.53 |
| 4 | 50.00 | 36.50 | 5 | 12.50 | | | 6.00 | 9.50 |
| 5 | 50.00 | 41.67 | 1 | | 3.33 | | 6.00 | 9.54 |
| 6 | 50.00 | 37.00 | 3 | | 10.00 | | 6.00 | 9.55 |
| 7 | 50.00 | 32.33 | 5 | | 16.67 | | 6.00 | 9.51 |
| 8 | 50.00 | 41.00 | 1 | | | 4.00 | 6.00 | 9.50 |
| 9 | 50.00 | 35.00 | 3 | | | 12.00 | 6.00 | 9.50 |
| 10 | 50.00 | 29.00 | 5 | | | 20.00 | 6.00 | 9.52 |

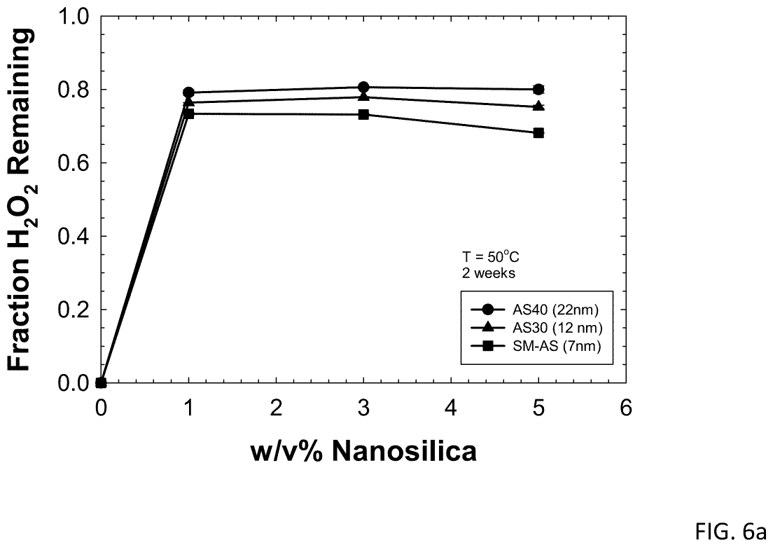

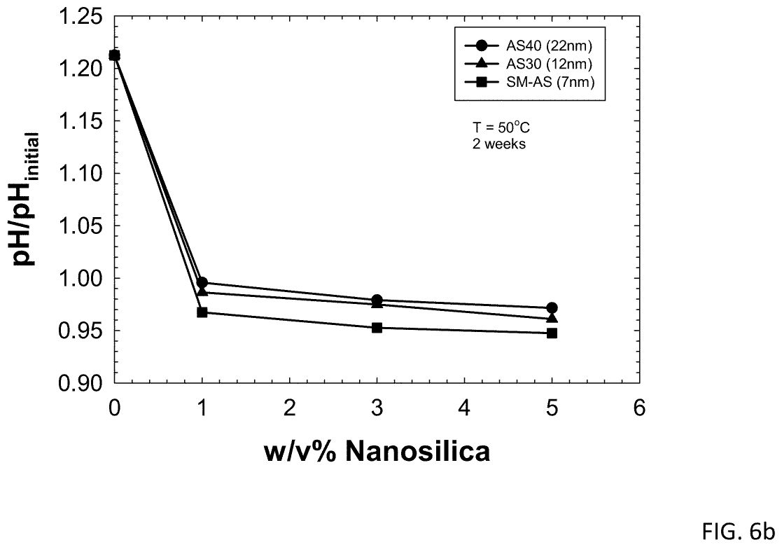

Samples were set up as in previous examples for 2 weeks at 50° C., monitoring peroxide level and pH at time zero and following incubation for 2 weeks. Peroxide measurements are shown in Table 12 below. FIG. 6a is a graph of the peroxide measurement data. The data show that within the range pf particle size studied (7-22 nm), the system with the largest particle size (22 nm) exhibited the best stability.

TABLE 12
Peroxide Measurements

| | | | | | Ave % | | Fract | |
|---|---|---|---|---|---|---|---|---|
| | | % | Ave % | | H₂O₂ 2 | err 2 | H₂O₂ 2 | |
| | Particle | silicate | H₂O₂ | | weeks | weeks | weeks | err |
| Sample | size (nm) | (w/v) | t0 | err t0 | 50° C. | 50° C. | 50° C. | fract |
| 1 | | 0 | 3.104 | 0.020 | 0.000 | 0.000 | 0.000 | 0.0000 |
| 2 | 22 | 1 | 3.028 | 0.005 | 2.397 | 0.023 | 0.791 | 0.0074 |
| 3 | | 3 | 2.952 | 0.007 | 2.380 | 0.009 | 0.806 | 0.0032 |
| 4 | | 5 | 2.873 | 0.002 | 2.298 | 0.029 | 0.800 | 0.0099 |
| 5 | 12 | 1 | 3.003 | 0.003 | 2.294 | 0.001 | 0.764 | 0.0003 |
| 6 | | 3 | 2.915 | 0.000 | 2.271 | 0.005 | 0.779 | 0.0019 |
| 7 | | 5 | 2.877 | 0.018 | 2.165 | 0.006 | 0.752 | 0.0046 |
| 8 | 7 | 1 | 3.154 | 0.004 | 2.314 | 0.014 | 0.734 | 0.004 |
| 9 | | 3 | 3.036 | 0 | 2.222 | 0.008 | 0.732 | 0.002 |
| 10 | | 5 | 2.962 | 0.047 | 2.020 | 0.004 | 0.682 | 0.001 |

Table 13 below shows the pH of the sample compositions, measured at time zero and after 2 weeks incubation period. FIG. 6b illustrates the data graphically. Values of pH were relatively stable for all of the systems containing nanosilicate.

TABLE 13
pH Values

| | Particle size | % silicate | | pH 2 weeks | |
|---|---|---|---|---|---|
| Sample | (nm) | (w/v) | pH t0 | 50° C. | pH/pH init |
| 1 | | 0 | 9.55 | 11.58 | 1.21 |
| 2 | 22 | 1 | 9.50 | 9.46 | 1.00 |
| 3 | | 3 | 9.53 | 9.33 | 0.98 |
| 4 | | 5 | 9.50 | 9.23 | 0.97 |
| 5 | 12 | 1 | 9.54 | 9.41 | 0.99 |
| 6 | | 3 | 9.55 | 9.31 | 0.97 |
| 7 | | 5 | 9.51 | 9.14 | 0.96 |
| 8 | 7 | 1 | 9.50 | 9.19 | 0.97 |
| 9 | | 3 | 9.50 | 9.05 | 0.95 |
| 10 | | 5 | 9.52 | 9.02 | 0.95 |

It was surprisingly discovered that the relative pH levels decreased during incubation as the particle sizes decreased. As it is expected that peroxide would have been more stability at lower pH, it is unexpected that the stability of the sample cleaning compositions increased with particle size. Systems with smaller particle size exhibited poorer peroxide stability even though their pH values at 2 weeks were lower.

Many modifications and other embodiments of the disclosure will come to mind to one skilled in the art to which this disclosure pertains having the benefit of the teachings presented in the foregoing description; and it will be apparent to those skilled in the art that variations and modifications of the present disclosure can be made without departing from the scope or spirit of the disclosure. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A liquid cleaning composition comprising:
a liquid medium comprising hydrogen peroxide, water, and nanoparticles dispersed in the liquid medium;
wherein said nanoparticles are insoluble in the liquid medium and exhibit an overall negative charge at the particle-liquid interface; and
wherein the cleaning composition is alkaline.

2. The cleaning composition of claim 1, wherein the nanoparticles have a particle size of at least about 5 nm.

3. The cleaning composition of claim 1, wherein the nanoparticles have a particle size of at least about 10 nm.

4. The cleaning composition of claim 1, wherein the nanoparticles have a particle size of at least about 20 nm.

5. The cleaning composition of claim 1, wherein the nanoparticles comprise nanosilicates.

6. The cleaning composition of claim 1, wherein the nanoparticles comprise a nanosilicate having an ammonium counter ion.

7. The cleaning composition of claim 1, wherein the nanoparticles comprise a deionized nanosilicate.

8. The cleaning composition of claim 1, wherein the pH of the cleaning composition is between 7 and 10.

9. The cleaning composition of claim 1, wherein said nanoparticles have a particle size of at least 5 nm and the nanoparticles comprise a nanosilicate having an ammonium counter ion.

10. The cleaning composition of claim 1, further comprising a surfactant.

11. The cleaning composition of claim 1, further comprising sodium dodecyl sulfate.

12. The cleaning composition of claim 1, further comprising a buffer configured to buffer the cleaning composition in a pH range of about 7 to about 10.

13. The cleaning composition of claim 1, wherein the nanoparticles are present in an amount of at least about 1% (w/v), based on the total volume of the liquid cleaning composition.

14. The cleaning composition of claim 1, wherein the nanoparticles are present in an amount of at least about 5% (w/v), based on the total volume of the liquid cleaning composition.

15. The cleaning composition of claim 1, wherein the hydrogen peroxide is present in an amount of at least about 1 wt. %, based on the total weight of the liquid cleaning composition.

16. The cleaning composition of claim 1, wherein the hydrogen peroxide is present in an amount of at least about 3 wt. %, based on the total weight of the liquid cleaning composition.

17. A method of cleaning a substrate, the method comprising:
applying the cleaning composition of claim 1 to a substrate for a sufficient period of time to treat the substrate; and
removing any excess cleaning composition from the substrate after treatment of the substrate.
